(19) United States
(12) Patent Application Publication
(10) Pub. No.: US 2026/0122650 A1
(43) Pub. Date: Apr. 30, 2026

(54) METHOD AND DEVICES FOR DETERMINING QUASI CO-LOCATION (QCL) PROPERTIES IN TRIGGERED CROSS-TRP RANDOM ACCESS

(71) Applicant: Nokia Technologies Oy, Espoo (FI)

(72) Inventors: Timo KOSKELA, Oulu (FI); Sami-Jukka HAKOLA, Oulu (FI); Juha Pekka KARJALAINEN, Oulu (FI)

(21) Appl. No.: 19/162,309

(22) PCT Filed: Feb. 12, 2024
(86) PCT No.: PCT/EP2024/053508

§ 371 Date: Sep. 4, 2025

Related U.S. Application Data
(60) Provisional application No. 63/488,857, filed on Mar. 7, 2023.

(51) Int. Cl. H04W 72/232; H04L 5/00; H04W 74/0833

(52) U.S. Cl. CPC H04W 72/232; H04L 5/0053; H04W 74/0833

(57) ABSTRACT

A method performed by a user equipment, including performing the steps of: receiving, from a network entity, a physical downlink control channel (PDCCH) carrying first downlink control information (DCI) that includes an indication with configurations to trigger or initiate an uplink transmission of a random access procedure towards at least one target downlink reference signal; and determining a quasi co-location (QCL) assumption for reception of second downlink control information that schedules a random access response (RAR) for the uplink transmission of the random access procedure.

### CROSS-REFERENCE TO RELATED APPLICATIONS/INCORPORATION BY REFERENCE

This application makes reference, to and claims priority to US Provisional Application (63/488,857), filed on Mar. 7, 2023. The content of which is incorporated in its entirety.

### TECHNICAL FIELD

Certain embodiments of the invention relate to feMIMO evolution work item, a method, a terminal device and a network device to carry out the multi timing advance (TA) maintenance/operation for facilitating triggered Physical Downlink Control Channel (PDCCH) ordered Physical Random Access Channel (PRACH) transmission in multi-TRP operations.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

### SUMMARY:

The invention relates to feMIMO evolution work item in RAN1. More specifically it relates to the multi TA maintenance/operation.

According to an exemplary embodiment, an apparatus may include at least one processor, and at least one memory. The memory may store instructions that, when executed by the processor, cause the apparatus to receive, from a network entity, a physical downlink control channel (PDCCH) carrying first downlink control information (DCI) that includes an indication with configurations to trigger or initiate an uplink transmission of a random access procedure towards at least one target downlink reference signal; and determine a quasi co-location (QCL) assumption for reception of second downlink control information that schedules a random access response (RAR) for the uplink transmission of the random access procedure.

According to an exemplary embodiment, the apparatus may include means for receiving, from a network entity, a physical downlink control channel (PDCCH) carrying first downlink control information (DCI) that includes an indication with configurations to trigger or initiate an uplink transmission of a random access procedure towards at least one target downlink reference signal; and means for determining a quasi co-location (QCL) assumption for reception of second downlink control information that schedules a random access response (RAR) for the uplink transmission of the random access procedure.

According to an exemplary embodiment is a method performed by a user equipment may include the steps of: receiving, from a network entity, a physical downlink control channel (PDCCH) carrying first downlink control information (DCI) that includes an indication with configurations to trigger or initiate an uplink transmission of a random access procedure towards at least one target downlink reference signal; and determining a quasi co-location (QCL) assumption for reception of second downlink control information that schedules a random access response (RAR) for the uplink transmission of the random access procedure.

According to an exemplary embodiment is a non-transitory computer readable storage medium storing instruction that, when executed by at least one processor of an apparatus, causes the apparatus at least to perform: receiving, from a network entity, a physical downlink control channel (PDCCH) carrying first downlink control information (DCI) that includes an indication with configurations to trigger or initiate an uplink transmission of a random access procedure towards at least one target downlink reference signal; and determining a quasi co-location (QCL) assumption for reception of second downlink control information that schedules a random access response (RAR) for the uplink transmission of the random access procedure. The uplink transmission may refer to the transmission of PRACH preamble(s) comprised in the random access procedure performed by the UE.

According to an exemplary embodiment, a network may include: at least one processor; and at least one memory storing instructions that, when executed by the at least one processor, cause the network entity at least to: send, to a user equipment (UE), a physical downlink control channel (PDCCH) carrying first downlink control information (DCI) that includes an indication with configurations to trigger or initiate in the UE, an uplink transmission of a random access procedure (e.g. a random access preamble) towards at least one target downlink reference signal transmitted by the apparatus, wherein the indication configures the UE to determine a quasi co-location (QCL) assumption for reception of second downlink control information; and schedule transmission, a random access response (RAR) to the UE, based on the downlink control information, in response to receiving PRACH preambles comprised in the random access procedure transmitted by the UE.

According to an exemplary embodiment, the network entity may include means for sending, to a user equipment (UE), a physical downlink control channel (PDCCH) carrying first downlink control information (DCI) that includes an indication with configurations to trigger or initiate in the UE, an uplink transmission of a random access procedure towards at least one target downlink reference signal transmitted by the apparatus, wherein the indication configures the UE to determine a quasi co-location (QCL) assumption for reception of second downlink control information; and means for scheduling transmission, a random access response (RAR) to the UE, based on the second downlink control information, in response to receiving PRACH preambles comprised in the random access procedure transmitted by the UE.

According to an exemplary embodiment is a method performed by a network entity may include the steps of: sending, to a user equipment (UE), a physical downlink control channel (PDCCH) carrying first downlink control information (DCI) that includes an indication with configurations to trigger or initiate in the UE, an uplink transmission of a random access procedure towards at least one target downlink reference signal transmitted by the apparatus, wherein the indication configures the UE to determine a quasi co-location (QCL) assumption for reception of second downlink control information; and scheduling transmission, a random access response (RAR) to the UE, based on the second downlink control information, in response to receiving PRACH preambles comprised in the random access procedure transmitted by the UE.

According to an exemplary embodiment is a non-transitory computer readable storage medium storing instruction that, when executed by at least one processor of a network entity, causes the network entity at least to perform: sending, to a user equipment (UE), a physical downlink control channel (PDCCH) carrying first downlink control information (DCI) that includes an indication with configurations to trigger or initiate in the UE, an uplink transmission of a random access procedure towards at least one target downlink reference signal transmitted by the apparatus, wherein the indication configures the UE to determine a quasi co-location (QCL) assumption for reception of second downlink control information; and scheduling transmission, a random access response (RAR) to the UE, based on the second downlink control information, in response to receiving PRACH preambles comprised in the random access procedure transmitted by the UE.

Some examples of QCL assumption may be described in the following way: a target signal/channel may be received as PDCCH/PDCCH DMRS. A source signal such as a SSB or CSI-RS or CSI-RS for tracking (TRS) may be used to provide UE QCL assumption(s) for the reception of the target signal, if the UE can assume that the source and target signal have similar characteristics in a form of at least one of the following parameters: doppler spread, doppler shift, time delay, time spread, or beam.

The source signal may provide the UE logic via TCI state. When the UE receives the source signal, the UE determines the above parameters to determine such as channel estimation filters and then may receive a target signal like PDCCH/PDCCH DMRS applying the determined channel estimation filters and the received beam (if beam domain is applicable, typically in FR2 only).

Certain exemplary embodiments may provide a non-transitory computer readable storage medium storing instruction that, when executed by at least one processor of an apparatus, may cause the apparatus at least to perform one or more of the methods herein. Various exemplary embodiments may provide one or more computer programs including instructions that, when executed by an apparatus, may cause the apparatus to perform one or more of the methods herein. Some exemplary embodiments may provide an apparatus including one or more circuitry configured to perform one or more of the methods herein.

### BRIEF DESCRIPTION OF THE DRAWINGS:

For proper understanding of example embodiments, reference should be made to the accompanying drawings, as follows:

FIG. 1 illustrates an example of a system diagram illustrating an intra-cell Multi-DCI cross TRP RACH triggering operation;

FIG. 2 illustrates an example of a system diagram illustrating both inter-cell and intra-cell Multi-DCI cross TRP RACH triggering operation;

FIG. 3 illustrates a set of apparatuses, according to various exemplary embodiments.

### DETAILED DESCRIPTION:

It will be readily understood that the components of certain example embodiments, as generally described and illustrated in the figures herein, may be arranged and designed in a wide variety of different configurations. The same reference designation may be used in multiple figures to refer to the same element or function. The following is a detailed description of some exemplary embodiments of systems, methods, apparatuses, and non-transitory computer program products for carrying out the multi timing advance (TA) maintenance/operation for facilitating triggered Physical Downlink Control Channel (PDCCH) ordered Physical Random Access Channel (PRACH) transmission in multi-transmission/reception point (TRP) operations.

Currently the cross-TRP triggered PDCCH ordered RACH is being considered. The open issues are the QCL properties and/or power control issues associated with the PRACH transmission. The QCL properties refer to the reception assumption for the subsequent messages in a contention free random access procedure. One of the issues with the QCL properties is that the Typel-Common Search Space (which is used for monitoring PDCCH scheduling the RAR on PDSCH) may not be configured for the CORESETs of a specific CORESETpoolIndex. CORESETs under the same value of CORESETpoolIndex may sometimes be referred as TRP(s)). As an example, the CORESETpoolIndex (or the TRP) which is the target for the PRACH transmission and the target for monitoring the response, may not have the search space (type 1 common) configured for monitoring the random access response. Random access response is monitored on PDCCH, in more particular, on a CORESET(s). The PDCCH provides the second DCI scheduling the RAR (and RAR may be provided by the PDSCH scheduled by the second DCI) for monitoring the response for the transmission. In some examples, the CORESETpoolIndex may be referred as one or more TRPs. In some examples, the CORESETpoolIndex, is a value that is associated with a CORESET (control resource set). The CORESETs having the same value of CORESETpoolIndex (e.g. 0 or 1) are considered to be grouped or pooled together. Thus the CORESETpoolindex may be referred to one or more CORESETs that are associated. The CORESET(s) are used to monitor random access response (e.g. DCI scheduling the random access response). In addition to the QCL rules, the transmission power control assumption for the PRACH needs to be determined.

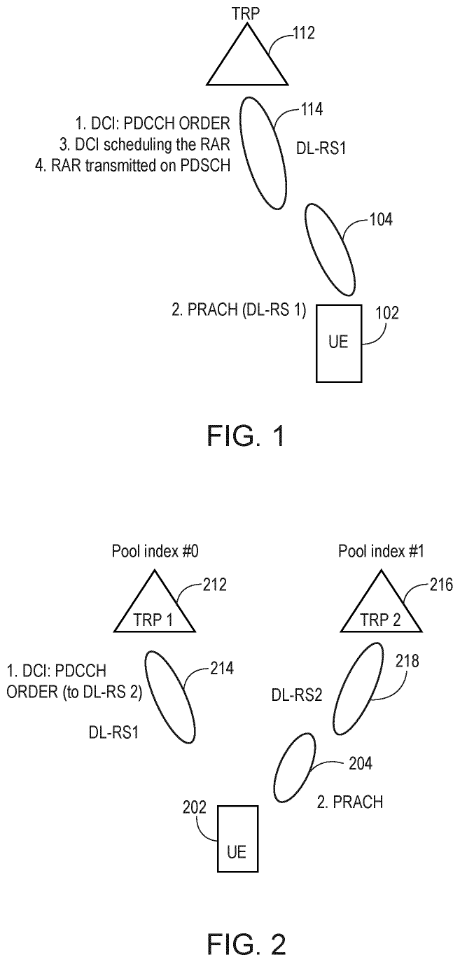

FIG. 1 illustrates an example of a system diagram illustrating both inter-cell and intra-cell Multi-DCI cross TRP RACH triggering operation. Referring to FIG. 1, in step 1, a user equipment (UE) 102 may receive, from a network entity (e.g., TRP 112), a physical downlink control channel (PDCCH) (e.g., spatial filter/beam 114), carrying first downlink control information (DCI) (see step 1) that includes an indication with configurations to trigger or initiate an uplink transmission (e.g., see step 2) of a random access procedure towards at least one target downlink reference signal (DL-RS1). In one example, the uplink transmission of a random access may use the target downlink reference signal (DL-RS1) (e.g. indicated in the first DCI that triggers the uplink transmission of a PRACH preamble) as reference for the UL transmission. In a case of intra-cell multiple TRP operation, target DL-RS1 or DL-RS2 may be used. In a case of both intra and inter-cell operations, both DL-RS1 and DL-RS2 may be used). As an example, the DL-RS2 may be provided by the TRP 112 (referred by the CORESETpoolIndex #1) of a same (intra-cell mTRP) or a different PCI (inter-cell mTRP) from that of the serving cell.

The UE 102 may determine a quasi co-location (QCL) assumption for reception of second downlink control information (DCI) (see step 3 in FIG. 1), which is used to schedule a random access response (RAR) (see step 4) for the uplink transmission of the random access procedure (e.g., UL transmission of PRACH preamble via spatial filter/beam 104). Any of the examples herein are not limited to any specific QCL type assumption. As an example, the QCL assumption may be at least a typeA QCL assumption (i.e., without typeD, which may mean that UE 102 may not use beamforming).

In one example, the QCL assumptions, which the quasi co-location types corresponding to each DL RS, are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}.

Conventionally, in some example cases, the PDCCH ordered RACH may have the following QCL assumptions: (a) The first DCI format that indicates the PDCCH ordered RACH, is typically transmitted using the same DL-RS1 as the reference as the target DL-RS for the PRACH transmission (e.g. DL-RS1->SSB index); (b) UE 102 determines to estimate the path loss for the UL power control for the RACH transmission based on the DL-RS1 that is quasi co-located (QCL'd) with the DMRS of PDCCH carrying the PDCCH ORDER (DCI message); (c) The second DCI scheduling the RAR is assumed to be QCL'd with the DCI triggering the PDCCH order (see step 1 in FIG. 1); and (d) The PDSCH carrying the RAR is QCL'D with the second DCI scheduling the RAR (see step 3. In FIG. 1). If the UE 102 attempts to detect the DCI format 1_0 with cyclic redundancy check (CRC) scrambled by the corresponding random access Radio Network Temporary Identifier (RA-RNTI) in response to a PRACH transmission initiated by a PDCCH order that triggers a contention-free random access procedure for the special cell (SpCell) [11, TS 38.321], the UE 102 may assume that the PDCCH that includes the second DCI format 1_0 and the PDCCH order may have same DM-RS antenna port quasi co-location properties.

Referring to the PDCCH order (see step 1 in FIG. 1), the current problem for cross-TRP triggering may include the QCL relationship/power control after PRACH (see step 2) triggered towards DL-RS 2 since if the UE assumes the response to the PRACH transmission to be monitored according to the target DL RS of the PRACH transmission (targeted behaviour/functionality) but the target CORESETpoolIndex may not be configured with CORESET associated with Type1-PDCCH CSS (common search space). This may mean that UE 102 may not be able to monitor the response to the PRACH transmission accordingly on the CORESET(s) of the target CORESETpoolIndex. Also, there is an ambiguity how the UE monitors the response when the order is triggered by the first TRP 112 (scheduled on the CORESET of CORESETpoolIndex #0) and the target is DL-RS of CORESETpoolIndex #1 (or vice versa). In other words, the UE behavior may not be clear in these situations with respect to the legacy rules.

As shown in FIG. 2, for multi-DCI based Multi-TRP operation with two timing advance (TA) enhancement, support the case where a PDCCH order (i.e. PDCCH ordered RACH procedure) sent by TRPx triggers RACH procedure towards either TRPx or TRPY for both inter-cell and intra-cell Multi-DCI. In an example, the disclosure includes considering the details of PRACH power control, and a QCL determination of PDCCH order, PDCCH (scheduling the) RAR or PDSCH RAR.

In implementation, there may be two CORESETpoolIndices, 0 and 1, which may be TRP indices (logical indices). If the PDCCH order is coming from a CORESET associated to CORESETpoolIndex 0, then the other index may refer to CORESETpoolIndex 1 (or vice versa).

In any of the examples herein, the QCL assumption for the PDCCH may refer to the QCL assumption of the PDCCH demodulation reference signal (DMRS). As an example, when a PDCCH is QCL'd with a DL-RS it may refer to the PDCCH DMRS being QCL'd with the DL-RS. In some examples, the DL-RS may be included in a TCI state configuration. Thus in some examples the TCI state (or the DL-RS included in the TCI state) may be QCL'd with PDCCH or PDSCH (DMRS). In some examples the DL-RS included in the TCI state configuration may be used as a reference for uplink transmission (e.g. PUCCH/PUSCH). A TCI state may include/comprise of one DL-RS having a first QCL type (e.g. type A) and/or two DL-RS having first QCL type (e.g. type A) and second DL-RS having a second QCL type (e.g. type D). IF the TCI state has two QCL types, the UE may use the one with QCL type D.

According to this embodiment, the first downlink control information may indicate a first value (e.g., =0) that may cause the UE 202 to determine the quasi co-location assumption for the PDCCH carrying second DCI scheduling the random access response to be same as the first DCI that triggers or initiates the random access procedure.

For example, in step 1 of FIG. 2, if the downlink control information indicates a first value (e.g. =0), the UE 202 may assume the QCL assumption for the PDCCH (PDCCH DMRS) carrying the second DCI scheduling the random access response to be same as the PDCCH (DMRS) that were used to transmit first DCI that triggered the PDCCH order.

In an example (option 1), if the first downlink control information indicates a second value (e.g. =1), the UE 202 assumes the QCL assumption for the PDCCH carrying the second DCI scheduling the random access response to be same as the DL RS that was indicated as target reference signal (RS) for the PRACH transmission (or DL RS associated to the PRACH transmission).

In another example (option 2), if the first downlink control information (DCI) indicates a second value (e.g. =1), the UE 202 may assume the QCL assumption for the PDCCH carrying the second DCI scheduling the random access response to be same as the DL RS of one of the activated TCI states of the different CORESETpoolIndex values that was indicated as target RS for the PRACH transmission.

In implementation, the one of the activated TCI states may include anyone of: a lowest active TCI state identifier in the active TCI state list, a most recent activated TCI state in the active TCI state list, or a lowest active TCI codepoint in the active TCI state list.

In another example (option 3), the downlink control information may indicate whether the first or the second indicated TCI state is used as a QCL assumption for the PDCCH (DMRS) that is used to transmit second DCI scheduling the random access response. In one example, whether the random access response follows (i.e. the response is assumed to be transmitted) the indicated TCI state (as a QCL reference) may be configured (e.g. by RRC) and/or indicated in a field in the DCI triggering the PDCCH order. In one example, if the random access response is configured to monitored using the indicated TCI State as assumption for the second DCI scheduling the random access response, UE may determine the QCL assumption based on the indicated TCI state.

In another example (option 4), the downlink control information may indicate whether the random access response is monitored on the CORESETpoolIndex value that triggered the transmission or on the CORESETpoolIndex that is different from the index that where the PDCCH order was triggered. CORESETpoolIndex may include one or more CORESETs.

In any of the embodiments above, if the first downlink control information indicates a second value (e.g. =1), the QCL assumption for the PDSCH scheduled by the second DCI for which the QCL assumption is determined as above, may be the same as the determined QCL assumption for PDCCH (DMRS) that is used to schedule the second DCI that schedules the random access response.

In one further embodiment if the downlink control information indicates a second value (e.g. =1), and the first triggering DCI is scheduled on the CORESET configured with a CORESETpoolIndex value 0 and the UE 202 determines the random access response to be monitored on CORESETs with poolIndex #1 (or vice versa). In a further example, if any of the CORESET(s) (of the poolIndex #1 or poolIndex #0, depending on the indication and which CORESETpoolindex #0 value was used to transmit the first triggering DCI) are not associated with CSS Typel (search space used for monitoring RAR response), the UE may determine to monitor the random access response using C-RNTI (cell radio network temporary identifier) (or RA-RNTI) on the UE-specific search space (USS) or Type3-CSS of the at least one CORESET ID associated with the poolindex #1 (or poolIndex #0).

In a further example, the UE may determine to monitor the random access response using C-RNTI (or RA-RNTI) on the USS or Type3-CSS of the at least one CORESET ID associated with the poolindex #1 (or poolIndex #0). In a further example, the UE may determine to monitor the random access response using C-RNTI (or RA-RNTI) on the any of the CSS configured on the at least one CORESET ID associated with the CORESETpoolIndex #1 (or poolIndex #0). The monitoring may be based on at least anyone of: a lowest CORESET ID, a CORESET ID (or a lowest/highest CORESET ID) that follows indicated unified TCI state, or a CORESET ID (lowest/highest) that is not associated with unified TCI State.

In one further embodiment, if the information in the first DCI triggering of the PDCCH order indicates a first value it may indicate that UE monitors the random access response with the same QCL assumption that of the PDCCH (DMRS) that was used to schedule the first triggering DCI. In one further example embodiment, if the information in the first DCI triggering the PDCCH order indicates a second value it may indicate that UE monitors the random access response with the QCL assumption of the target DL-RS indicated by the triggering first DCI. In one further example embodiment, if the information in the first DCI triggering the PDCCH order indicates a second value, it may indicate that UE monitors the random access response with the determined QCL assumption of the CORESET of a different CORESETpoolIndex value that was used to transmit the first triggering DCI. The QCL assumption may be indicated or activated TCI state associated with the CORESETpoolIndex value different than the PDCCH (DMRS) that was used to schedule the first triggering DCI that was used to t (e.g. =1 or it indicates that UE uses CORESET of other CORESETpoolIndex for response monitoring).

In one further embodiment if the first downlink control information indicates a second value (e.g. =1), and the first triggering DCI is scheduled on the CORESET configured with a CORESETpoolIndex value 0 and the UE determines the response to be monitored on CORESETs with poolIndex #1, and the CORESETs (of the poolIndex #1) are not associated with CSS Typel (search space used for monitoring RAR response), the UE may determine to monitor the response using C-RNTI (or RA-RNTI) on the USS or Type3-CSS of the at least one CORESET ID associated with the poolIndex #1. The monitoring may be based on at least anyone of: a lowest CORESET ID, a CORESET ID (or a lowest/highest CORESET ID) that follows indicated unified TCI state, or a CORESET ID (lowest/highest) that is not associated with unified TCI State. The above embodiment may also be considered vice versa in terms of CORESETpoolIndex #value.

In one embodiment, the interpretation of the first and second value may depend on which CORESET (configured with the CORESETpoolIndex value) the first DCI triggering the PDCCH ordered random access procedure is scheduled. Thus the interpretation of the information field (providing first/second/one of the values) in the first DCI may be conditionally interpreted or may have dependency on further parameters or assumptions. In one example, if the CORESET that is transmitting the PDCCH carrying the first DCI (PDCCH ORDER) is configured with CORESETPoolIndex #0, one of the values (e.g. 1) of the information field may refer to the CORESETPoolindex #1. In one example, if the CORESET is configured with CORESETPoolIndex #1, one of the values (e.g. 1) of the information field may refer to the CORESETPoolindex #0. Thus the UE 202 may interpret the value in the first DCI (PDCCH ORDER) depending on the CORESETs association to the CORESETpoolIndex. As a further example, the first value may indicate that the UE monitors the random access response (RAR) on the CORESET of the same CORESETpoolindex that was used to transmit the first DCI (PDCCH order). The second value may indicate that the UE 202 monitors the random access response on the CORESET of the other/different CORESETpoolindex that was used to transmit the DCI (PDCCH order)

In one embodiment, the value and the association to the CORESETpoolIndex of the information field may be configurable. As an example, the first value (e.g. 0) is configured to indicate the first value of the CORESETpoolIndex (e.g. 0). In another example, the second value (e.g. 1) is configured to indicate a second value of the CORESETpoolIndex (e.g. 1). In an example, the first value may indicate that the UE monitors the random access response on the CORESET of the CORESETpoolindex associated with the value (e.g. 0). The second value may indicate that the UE 202 monitors the random access response on the CORESET of the CORESETpoolindex associated with the second value (e. g 1). Thus the random access response monitoring (and selection of the CORESETpoolIndex for determining the assumptions for the random access response monitoring) is determined by the UE 202 based on the information field indicating the CORESETpoolIndex value.

In one embodiment, one field in the first DCI that triggers PDCCH ordered random access, may indicate whether the UE monitors the RA response on CSS (e.g. using RA-RNTI or C-RNTI) or on the USS (using C-RNTI or RA-RNTI).

In one further embodiment if the information indicates a second value (e.g. =1 or it indicates that UE uses CORESET of other CORESETpoolIndex for response monitoring), the UE 202 may determine the path loss 204 for the PRACH power control based on the SSB (or the target DL-RS2) associated with the PRACH preamble, if the SSB (or the target DL-RS2) is configured as QCL source for one of the TCI states (e.g. activated TCI states) or based on the PDCCH DMRS of the indicated TCI state, if the SSB (or the target DL-RS2) is the QCL source for the TCI State. The target DL-RS2 may be one of a SSB or CSI-RS.

In one embodiment the UE 202 may determine the path loss 204 for the PRACH power control based on the SSB (or the DL-RS2) included in the indicated TCI state. In one example, the UE 202 may base the power control on the indicated TCI state for the CORESETPoolIndex value. In one example the UE may base the power control on the indicated TCI (the DL-RS2 included in the TCI State) state for the CORESETPoolIndex value when the first DCI carrying the PDCCH order indicates that the random access response is monitored on the CORESETs of the different CORESETPoolIndex value that the CORESET used to transmit DCI (PDCCH order).

In one example the second value/one of the values indicated by the first DCI (PDCCH order) may indicate that the UE 202 monitors the DCI scheduling the random access response on CORESET(s) of a different CORESETpoolIndex than the CORESETpoolIndex used to transmit the second DCI that triggered the random access transmission. If the indicated TCI state includes two DL-RS (i.e., DL-RS1, DL-RS2), the UE 202 may use the one configured with a QCL-typeD.

In any of the embodiments herein, the first DCI includes the first and second value may be provided on a form of a (bit)field in a first DCI message that triggers the PDCCH ordered random access procedure. Whether the field is present, may be configurable by network (i.e. via RRC signaling). Instead of referring to the first and/or second values, the information may be referred as “one of the values”. The values first and second may also be interchanged, vice versa (first =1 and second =0).

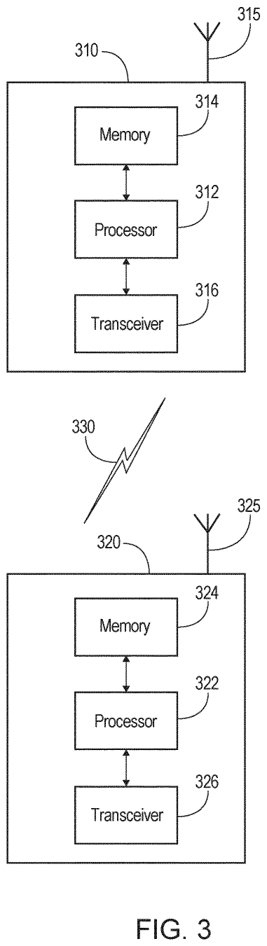

FIG. 3 illustrates a set of apparatuses, according to various exemplary embodiments.

According to certain exemplary embodiments, the apparatus 320 may be further caused to carry out the multi timing advance (TA) maintenance/operation for facilitating triggered Physical Downlink Control Channel (PDCCH) ordered Physical Random Access Channel (PRACH) transmission in multi-TRP operations.

FIG. 3 illustrates a set of apparatuses 310 and 320 according to various exemplary embodiments to perform the steps and functions illustrated in FIGS. 1-2. In the various exemplary embodiments, the apparatus 310 may be an element in a communications network or associated with such a network, such as a UE, RedCap UE, SL UE, mobile equipment (ME), mobile station, mobile device, stationary device, IoT device, or other user device. For example, the UEs 102 or 202, according to various exemplary embodiments as discussed above may be examples of apparatus 310. It should be noted that one of ordinary skill in the art would understand that apparatus 310 may include components or features not shown in FIG. 3. In addition, apparatus 320 may be a network, network entity, element of the core network, or element in a communications network or associated with such a network, such as a base station, an NE, or a gNB. For example, the network and the gNB 112, 212 and 216, according to various exemplary embodiments discussed above may be examples of apparatus 320. It should be noted that one of ordinary skill in the art would understand that apparatus 320 may include components or features not shown in FIG. 6.

According to a first exemplary embodiment of the apparatus 310 (i.e., user equipment 102, 202) as shown in FIGS. 1-2. The apparatus 310 (i.e., user equipment 102, 202) may include at least one processor 312, and at least one memory 314, as shown in FIG. 3. The memory 314 may store instructions that, when executed by the processor 312, cause the apparatus 310 to receive, from a network entity 320 (i.e., network entity 112 or 212 and 216 as shown in FIGS. 1-2), a physical downlink control channel (PDCCH) carrying first downlink control information (DCI) that includes an indication with configurations to trigger or initiate an uplink transmission of a random access procedure towards at least one target downlink reference signal; and determine a quasi co-location (QCL) assumption for reception of second downlink control information that schedules a random access response (RAR) for the uplink transmission of the random access procedure.

According to a second exemplary embodiment of the apparatus 310 (i.e., user equipment 102, 202) as shown in FIGS. 1-2, the downlink control information indicates a first value that causes the apparatus to determine the quasi co-location assumption for the PDCCH carrying the second DCI scheduling the random access response to be same as the first DCI that triggers or initiates the random access procedure.

According to a third exemplary embodiment of the apparatus 310 (i.e., user equipment 102, 202) as shown in FIGS. 1-2, the first downlink control information indicates a second value that causes the apparatus to determine the quasi co-location assumption for the PDCCH carrying second DCI scheduling the random access response to be same as the at least one downlink reference signal indicated by the received first DCI carried by the PDCCH as the target reference signal to trigger the uplink transmission of the random access procedure.

According to a fourth exemplary embodiment of the apparatus 310 (i.e., user equipment 102, 202) as shown in FIGS. 1-2, the first downlink control information indicates a second value that causes the apparatus to determine the quasi co-location (QCL) assumption for the PDCCH carrying the second DCI when scheduling the random access response to be same as the at least one downlink reference signal of an indicated transmission control indicator (TCI) state of a CORESETpoolIndex value which is different from an index value which was used to schedule the PDCCH that comprises the indication to trigger the uplink transmission of the random access procedure.

According to a fifth exemplary embodiment of the apparatus 310 (i.e., user equipment 102, 202) as shown in FIGS. 1-2, the first downlink control information indicates a second value that causes the apparatus to determine the quasi co-location assumption for the PDCCH carrying the second DCI scheduling the random access response to be same as the at least one downlink reference signal of at least one of activated TCI states of a CORESETpoolIndex value which is different from the CORESETPoolIndex value that was used to trigger the uplink transmission of the random access procedure.

According to a sixth exemplary embodiment of the apparatus 310 (i.e., user equipment 102, 202) as shown in FIGS. 1-2, the one of the activated TCI states includes anyone of: a lowest active TCI state identifier in the active TCI state list, a most recent activated TCI state in the active TCI state list, or a lowest active TCI codepoint in the active TCI state list.

According to a seventh exemplary embodiment of the apparatus 310 (i.e., user equipment 102, 202) as shown in FIGS. 1-2, the downlink control information indicates the first or the second value that is used as the QCL assumption for the PDCCH carrying the second DCI that schedules the random access response to be same as a first indicated TCI state when the indication indicates the first value, and a second indicated TCI state when the indication indicates the second value.

According to an eighth exemplary embodiment of the apparatus 310 (i.e., user equipment 102, 202) as shown in FIGS. 1-2, the downlink control information indicates the second value that causes the apparatus to determine that the quasi co-location assumption for the PDCCH carrying the second DCI that schedules the random access response to be based on the CORESETpoolIndex value associated with the PDCCH: wherein the first value indicates that the QCL assumption for the monitoring the response is determined to be on the same CORESETpoolIndex value that was used to trigger the first DCI indicating the RACH, and wherein second value indicates that the QCL assumption for the monitoring the response is determined to be on the other CORESETpoolIndex value that was used to trigger the first DCI indicating the RACH.

According to a nineth exemplary embodiment of the 310 (i.e., user equipment 102, 202) as shown in FIGS. 1-2, the first downlink control information indicates the second value that causes the apparatus to determine that the quasi co-location assumption for the PDCCH carrying the second DCI that schedules the random access response to be based on a configuration of whether a common search space type used for monitoring the second DCI scheduling the random access response is configured.

According to a tenth exemplary embodiment of the apparatus 310 (i.e., user equipment 102, 202) as shown in FIGS. 1-2, the apparatus is configured to determine that when the search space type is not configured, monitor the PDCCH that carries scheduling command for the random access response on at least one of: a lowest CORESET ID, a CORESET ID that follows unified TCI state, or a CORESET ID (lowest) that is not associated with the unified TCI State.

According to an eleventh exemplary embodiment of the apparatus 310 (i.e., user equipment 102, 202) as shown in FIGS. 1-2, the uplink transmission of the random access procedure includes transmission of PRACH preambles associated with the at least one target downlink reference signal.

According to a twelve exemplary embodiment of a network entity 320 (i.e., network entity 112, 212, 216) as shown in FIGS. 1-2. The network entity 320 may include: at least one processor 322; and at least one memory 324 storing instructions that, when executed by the at least one processor, cause the network entity at least to: send, to a user equipment (UE), a physical downlink control channel (PDCCH) carrying first downlink control information (DCI) that includes an indication with configurations to trigger or initiate in the UE, an uplink transmission of a random access procedure towards at least one target downlink reference signal transmitted by the apparatus, wherein the indication configures the UE to determine a quasi co-location (QCL) assumption for the received second downlink control information; and schedule transmission, a random access response (RAR) to the UE, based on the second downlink control information, in response to receiving PRACH preambles comprised in the random access procedure transmitted by the UE.

According to a thirteenth exemplary embodiment of the apparatus 310 (i.e., user equipment 102, 202) as shown in FIGS. 1-2, 13. The apparatus includes: means for receiving, from a network entity, a physical downlink control channel (PDCCH) carrying first downlink control information (DCI) that includes an indication with configurations to trigger or initiate an uplink transmission of a random access procedure towards at least one target downlink reference signal; and means for determining a quasi co-location (QCL) assumption for reception of second downlink control information that schedules a random access response (RAR) for the uplink transmission of the random access procedure.

According to a fourteenth exemplary embodiment of a method performed by an apparatus 310 (i.e., user equipment 102, 202) as shown in FIGS. 1-2, the method includes: receiving, from a network entity, a physical downlink control channel (PDCCH) carrying first downlink control information (DCI) that may include an indication with configurations to trigger or initiate an uplink transmission of a random access procedure towards at least one target downlink reference signal; and determining a quasi co-location (QCL) assumption for reception of second downlink control information that schedules a random access response (RAR) for the uplink transmission of the random access procedure.

According to a fifteenth exemplary embodiment of a non-transitory computer readable storage medium storing instruction that, when executed by at least one processor of an apparatus 310 (i.e., user equipment 102, 202) as shown in FIGS. 1-2, causes the apparatus at least to perform: receiving, from a network entity, a physical downlink control channel (PDCCH) carrying first downlink control information (DCI) that may include an indication with configurations to trigger or initiate an uplink transmission of a random access procedure towards at least one target downlink reference signal; and determining a quasi co-location (QCL) assumption for the reception of the second downlink control information that schedules a random access response (RAR) for the uplink transmission of the random access procedure.

According to a sixteenth exemplary embodiment of a network entity 320 (i.e., network entity 112, 212, 216) as shown in FIGS. 1-2. The network entity 320 may include: means for sending, to a user equipment (UE), a physical downlink control channel (PDCCH) carrying first downlink control information (DCI) that may include an indication with configurations to trigger or initiate in the UE, an uplink transmission of a random access procedure towards at least one target downlink reference signal transmitted by the apparatus, wherein the indication configures the UE to determine a quasi co-location (QCL) assumption for reception of second downlink control information; and means for scheduling transmission, a random access response (RAR) to the UE, based on the second downlink control information, in response to receiving PRACH preambles comprised in the random access procedure transmitted by the UE.

According to a seventeenth exemplary embodiment of a method performed by a network entity 320 (i.e., network entity 112, 212, 216) as shown in FIGS. 1-2. The method may include: sending, to a user equipment (UE), a physical downlink control channel (PDCCH) carrying first downlink control information (DCI) that may include an indication with configurations to trigger or initiate in the UE, an uplink transmission of a random access procedure towards at least one target downlink reference signal transmitted by the apparatus, wherein the indication configures the UE to determine a quasi co-location (QCL) assumption for reception of second downlink control information; and scheduling transmission, a random access response (RAR) to the UE, based on the second downlink control information, in response to receiving PRACH preambles comprised in the random access procedure transmitted by the UE.

According to an eighteenth exemplary embodiment of a non-transitory computer readable storage medium storing instruction that, when executed by at least one processor of a network entity, causes the network entity at least to perform: sending, to a user equipment (UE), a physical downlink control channel (PDCCH) carrying first downlink control information (DCI) that may include an indication with configurations to trigger or initiate in the UE, an uplink transmission of a random access procedure towards at least one target downlink reference signal transmitted by the apparatus, wherein the indication configures the UE to determine a quasi co-location (QCL) assumption for reception of second downlink control information; and scheduling transmission, a random access response (RAR) to the UE, based on the second downlink control information, in response to receiving PRACH preambles comprised in the random access procedure transmitted by the UE.

In some example embodiments, apparatuses 310 and/or 320 may include one or more processors, one or more computer-readable storage medium (for example, memory, storage, or the like), one or more radio access components (for example, a modem, a transceiver, or the like), and/or a user interface. In some example embodiments, apparatuses 310 and/or 320 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 3, apparatuses 310 and/or 320 may include or be coupled to processors 312 and 322, respectively, for processing information and executing instructions or operations. Processors 312 and 322 may be any type of general or specific purpose processor. In fact, processors 312 and 322 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 312 (and 322) for each of apparatuses 310 and/or 320 is shown in FIG. 3, multiple processors may be utilized according to other example embodiments. For example, it should be understood that, in certain example embodiments, apparatuses 310 and/or 320 may include two or more processors that may form a multiprocessor system (for example, in this case processors 312 and 322 may represent a multiprocessor) that may support multiprocessing. According to certain example embodiments, the multiprocessor system may be tightly coupled or loosely coupled to, for example, form a computer cluster).

Processors 312 and 322 may perform functions associated with the operation of apparatuses 310 and/or 320, respectively, including, as some examples, precoding of antenna gain/phase parameters, encoding and decoding of individual bits forming a communication message, formatting of information, and overall control of the apparatuses 310 and/or 320, including processes illustrated in FIGS. 1-2.

Apparatuses 310 and/or 320 may further include or be coupled to memory 314 and/or 324 (internal or external), respectively, which may be coupled to processors 312 and 322, respectively, for storing information and instructions that may be executed by processors 312 and 322. Memory 314 (and memory 324) may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 314 (and memory 324) can be included of any combination of random access memory (RAM), read only memory (ROM), static storage such as a magnetic or optical disk, hard disk drive (HDD), or any other type of non-transitory machine or computer readable media. The instructions stored in memory 314 and memory 324 may include program instructions or computer program code that, when executed by processors 312 and 322, enable the apparatuses 310 and/or 320 to perform tasks as described herein.

In certain example embodiments, apparatuses 310 and/or 320 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 312 and 322 and/or apparatuses 310 and/or 320 to perform any of the methods illustrated in FIGS. 1-2.

In some exemplary embodiments, apparatus 310 may also include or be coupled to one or more antennas 315 for receiving a downlink signal and for transmitting via an uplink from apparatus 310. Apparatuses 310 and/or 320 may further include transceivers 316 and 326, respectively, configured to transmit and receive information. The transceiver 316 and 326 may also include a radio interface that may correspond to a plurality of radio access technologies including one or more of GSM, LTE, LTE-A, 5G, NR, WLAN, NB-IoT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceivers 316 and 326 may be respectively configured to modulate information on to a carrier waveform for transmission, and demodulate received information for further processing by other elements of apparatuses 310 and/or 320. In other example embodiments, transceivers 316 and 326 may be capable of transmitting and receiving signals or data directly. Additionally or alternatively, in some example embodiments, apparatuses 310 and/or 320 may include an input and/or output device (I/O device). In certain example embodiments, apparatuses 310 and/or 320 may further include a user interface, such as a graphical user interface or touchscreen.

In certain example embodiments, memory 314 and memory 324 store software modules that provide functionality when executed by processors 312 and 322, respectively. The modules may include, for example, an operating system that provides operating system functionality for apparatuses 310 and/or 320. The memory may also store one or more functional modules, such as an application or program, to provide additional functionality for apparatuses 310 and/or 320. The components of apparatuses 310 and/or 320 may be implemented in hardware, or as any suitable combination of hardware and software. According to certain example embodiments, apparatus 310 may optionally be configured to communicate with apparatus 320 via a wireless or wired communications link 330 according to any radio access technology, such as NR.

According to certain example embodiments, processors 312 and 322, and memory 314 and 324 may be included in or may form a part of processing circuitry or control circuitry. In addition, in some example embodiments, transceivers 313 and 326 may be included in or may form a part of transceiving circuitry.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 310 and/or 320) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 310 and/or 320), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

CSI Channel State Information
CORESET Control Resource Set
CSI-RS Channel State Information Reference Signal
CSS Common Search Space Set
DCI Downlink Control Information
DL Downlink
DMRS Demodulation Reference Signal
PDCCH Physical Downlink Control Channel
PRACH Physical Random Access Channel
QCL Quasi Co-location
RACH Random Access Channel
RAR Random Access Response
RNTI Radio Network Temporary Identifier
RA-RNTI Random Access-Radio Network Temporary IdentifierRS

### REFERENCE SIGNAL

SSB Synchronization Signal and PBCH Block
TCI Transmission Coordination Indicator
TRP Transmission and Reception Point
UE User Equipment
UL Uplink
USS User Specific Search Space

We claim:

1. An apparatus for wireless communication, comprising:
at least one processor; and
at least one memory storing instructions that, when executed by the at least one processor, cause the apparatus at least to:
receive, from a network entity, a physical downlink control channel (PDCCH) carrying first downlink control information (DCI) that comprises an indication with configurations to trigger or initiate an uplink transmission of a random access procedure towards at least one target downlink reference signal, wherein the first downlink control information indicates a second value that causes the apparatus to determine the quasi co-location assumption for the PDCCH carrying the second DCI when scheduling the random access response, to be same as the at least one downlink reference signal of an indicated transmission control indicator (TCI) state of a CORESETpoolIndex value, which is different from an index value which was used for the PDCCH that comprises the indication to trigger the uplink transmission of the random access procedure; and
determine a quasi co-location (QCL) assumption for reception of second downlink control information that schedules a random access response (RAR) for the uplink transmission of the random access procedure.

2. The apparatus according to claim 1, wherein the first downlink control information indicates a first value that causes the apparatus to determine the quasi co-location assumption for the PDCCH carrying the second DCI that schedules the random access response, to be same as the DCI that triggers or initiates the random access procedure.

3. The apparatus according to claim 1, wherein the first downlink control information indicates a second value that causes the apparatus to determine the quasi co-location assumption for the PDCCH carrying the second DCI that schedules the random access response, to be same as the at least one downlink reference signal indicated by the received DCI carried by the PDCCH, as the target reference signal to trigger the uplink transmission of the random access procedure.

4. (canceled)

5. The apparatus according to claim 1, wherein the first downlink control information indicates a second value that causes the apparatus to determine the quasi co-location assumption for the PDCCH carrying the second DCI scheduling the random access response, to be same as the at least one downlink reference signal of at least one of activated TCI states of a CORESETpoolIndex value which is different from the CORESETPoolIndex value that was used to trigger the uplink transmission of the random access procedure.

6. The apparatus according to claim 5, wherein the one of the activated TCI states comprises anyone of:
a lowest active TCI state identifier in the active TCI state list,
a most recent activated TCI state in the active TCI state list, or
a lowest active TCI codepoint in the active TCI state list.

7. The apparatus according to claim 5, wherein the first downlink control information indicates the first or the second value that is used as the QCL assumption for the PDCCH carrying the second DCI that schedules the random access response to be same as a first indicated TCI state when the indication indicates the first value, and a second indicated TCI state when the indication indicates the second value.

8. The apparatus according to claim 1, wherein the first downlink control information indicates the second value that causes the apparatus to determine that the quasi co-location assumption for the PDCCH carrying the second DCI that schedules the random access response to be based on the CORESETpoolIndex value associated with the PDCCH:
wherein the first value indicates that the QCL assumption for the monitoring the response is determined to be on the same CORESETpoolIndex value that was used to trigger the first DCI indicating the RACH,
wherein second value indicates that the QCL assumption for the monitoring the response is determined to be on the other CORESETpoolIndex value that was used to trigger the DCI indicating the RACH.

9. The apparatus according to claim 1, wherein the first downlink control information indicates the second value that causes the apparatus to determine that the quasi co-location assumption for the PDCCH carrying the secondDCI that schedules the random access response to be based on a configuration of whether a common search space type used for monitoring the second DCI scheduling the random access response is configured.

10. The apparatus according to claim 1, wherein the apparatus is further caused to determine that when the search space type is not configured, monitor the PDCCH that carries scheduling command for the random access response on at least one of:
a lowest CORESET ID,
a CORESET ID that follows unified TCI state, or
a CORESET ID (lowest) that is not associated with the unified TCI State.

11. The apparatus according to claim 1, wherein the uplink transmission of the random access procedure comprises transmission of PRACH preambles associated with the at least one target downlink reference signal.

12. (canceled)

13. A method of wireless communication performed by an apparatus, comprising
receiving, from a network entity, a physical downlink control channel (PDCCH) carrying first downlink control information (DCI) that comprises an indication with configurations to trigger or initiate an uplink transmission of a random access procedure towards at least one target downlink reference signal, wherein the first downlink control information indicates a second value that causes the apparatus to determine the quasi co-location assumption for the PDCCH carrying the second DCI when scheduling the random access response, to be same as the at least one downlink reference signal of an indicated transmission control indicator (TCI) state of a CORESETpoolIndex value, which is different from an index value which was used for the PDCCH that comprises the indication to trigger the uplink transmission of the random access procedure; and
determining a quasi co-location (QCL) assumption for reception of second downlink control information that schedules a random access response (RAR) for the uplink transmission of the random access procedure.

14. (canceled)

15. A network entity for wireless communication, comprising:
at least one processor; and
at least one memory storing instructions that, when executed by the at least one processor, cause the apparatus at least to:
send, to a user equipment (UE), a physical downlink control channel (PDCCH) carrying first downlink control information (DCI) that comprises an indication with configurations to trigger or initiate in the UE, an uplink transmission of a random access procedure towards at least one target downlink reference signal transmitted by the apparatus, wherein the indication configures the UE to determine a quasi co-location (QCL) assumption for reception of second downlink control information, wherein the first downlink control information indicates a second value that causes the apparatus to determine the quasi co-location assumption for the PDCCH carrying the second DCI when scheduling the random access response, to be same as the at least one downlink reference signal of an indicated transmission control indicator (TCI) state of a CORESETpoolIndex value, which is different from an index value which was used for the PDCCH that comprises the indication to trigger the uplink transmission of the random access procedure; and
schedule transmission, a random access response (RAR) to the UE, based on the second downlink control information, in response to receiving PRACH preambles comprised in the random access procedure transmitted by the UE.

16-18. (canceled)
